(19) United States
(12) Patent Application Publication
(10) Pub. No.: US 2013/0009735 A1
(43) Pub. Date: Jan. 10, 2013

(54) PERMANENT MAGNET OPTIONS FOR MAGNETIC DETECTION AND SEPARATION - RING MAGNETS WITH A CONCENTRIC SHIM

(75) Inventors: Pulak Nath, Los Alamos, NM (US); Kanaka Chaitanya Kumar Chandrana, White Rock, NM (US)

(73) Assignee: Los Alamos National Security, LLC

(21) Appl. No.: 13/495,963

(22) Filed: Jun. 13, 2012

Related U.S. Application Data
(60) Provisional application No. 61/496,362, filed on Jun. 13, 2011.

(51) Int. Cl. H01F 7/02

(52) U.S. Cl. 335/302

(57) ABSTRACT

Permanent magnet assemblies include a central cylindrical magnet having a bore. The cylindrical magnet is magnetized along a selected radial direction and is enclosed within a ferromagnetic shim. A uniform magnetic field, field gradient, or other field distribution can be produced in the bore based on the bore cross-sectional shape.

### CROSS REFERENCE TO RELATED APPLICATION

This application claims the benefit of U.S. Provisional Application 61/496,362, filed Jun. 13, 2011 which is incorporated herein by reference.

### ACKNOWLEDGMENT OF GOVERNMENT SUPPORT

This invention was made with government support under Contract No. DE-AC52-06NA25396 awarded by the U.S. Department of Energy. The government has certain rights in the invention.

### FIELD

The disclosure pertains to ring magnets and applications thereof.

### BACKGROUND

Magnetic field patterns are critical for some applications. For example, a gradient magnetic field is required for magnetic separation, whereas a highly uniform field is required for magnetic detection using NMR. Magnetic fields for magnetic separation and detection are typically obtained using an array of precisely oriented permanent magnets such as a quadrupole magnet or a Halbach array. See, for example, Blumich et al., U.S. Patent Application Publication 2010/0013473, which is incorporated herein by reference. Precise alignments of the multiple magnets required by these configurations can make the fabrication of such magnetic circuits difficult, time consuming and expensive. In addition, tedious user re-alignments can be required.

### SUMMARY

According to representative examples, magnet assemblies comprise a permanent magnet defining an air gap and a ferromagnetic shim situated about the permanent magnet. Typically, the permanent magnet and the ferromagnetic shim are cylindrical, and the ferromagnetic shim is situated so as to be concentric with the permanent magnet. A permanent magnet magnetization is directed so as to be in a plane perpendicular to an axis of the permanent magnet. In some examples, the cylindrical permanent magnet has a magnetization that is directed along a diameter of the cylindrical cross section of the cylindrical permanent magnet. In other examples, the air gap in the permanent magnet has a circular cross-section concentric with the permanent magnet. According to other examples, the air gap in the permanent magnet has a square cross-section centered with the permanent magnet and a diagonal of the square cross-section is aligned with the magnetization of the permanent magnet. In still further examples, a Halbach array is situated in the air gap in the permanent magnet.

Methods comprise selecting a magnetic field distribution in at least one plane and providing a ring permanent magnet having an internal air gap associated with the selected magnetic field distribution, wherein the magnetization is parallel to the plane. A ferromagnetic shim is then situated about the permanent magnet. In some examples, the magnetization of the magnet is parallel to a diameter of the ring and the internal air gap has a circular cross-section. In other representative embodiments, the ring magnet and the shim are circular cylinders. In some embodiments, the ring magnet and the shim have non-circular cross-sections in a plane parallel to the magnetization. In some embodiments, the internal air gap has a rectangular cross-section. In other examples, a diagonal of the rectangular cross-section is aligned with the magnetization of the permanent magnet. In other embodiments, the cross-section of the shape of the air-gap is a circle or polygon. In some examples, the cross-sections of the shape of the inner and/or outer surfaces of the magnet are a circle or polygon. In still further examples, the cross-section of the shape of the inner and/or outer surface of the shim is a circle or polygon. In further examples, the air gap, the outer surface of the magnet, and the inner and outer surfaces of the shim have similar shapes that are aligned with respect to each other.

Magnet assemblies comprise a magnetized cylinder having a central bore and having a magnetization that is along a direction of a selected radius of the cylinder. A ferromagnetic shim is situated about the magnetized cylinder. A first set of cylindrical magnets and a second set of cylindrical magnets are alternately situated at an inner surface of the central bore such that the first set of magnets have magnetizations parallel to the magnetization of the magnetized cylinder and the second set of magnets have magnetizations perpendicular to the magnetization of the magnetized cylinder. In some examples, the ferromagnetic shim is spaced apart from the magnetized cylinder so as to form an air gap. In other examples, the ferromagnetic shim comprises first and second half cylindrical shells situated to form a cylindrical shell about the magnetized cylinder and the magnetized cylinder comprises a plurality of sections.

### BRIEF DESCRIPTION OF THE DRAWINGS

FIG. 1A is a perspective view of a magnet assembly that includes a cylindrical magnet having a central bore situated inside of and coaxial with a ferromagnetic cylindrical shim

FIG. 1B is a sectional view of a magnet assembly such as that of FIG. 1A illustrating a diametrically magnetized ring magnet situated within a circular bore of a coaxial ferromagnetic cylindrical ring shim defining an air gap in which selected magnetic field distributions can be produced.

FIG. 1C is a sectional view of a magnet assembly such as the magnet assembly of FIG. 1B.

FIGS. 2A-2C illustrate modeling results showing field distributions for a shimmed ring magnet design with circular air gap in which ID_{M}=1 cm, OD_{M}=3.2 cm, ID_{S}=3.2 cm, OD_{S}=7.6 cm, and S_{MS}=0.0 cm. FIG. 2A illustrates the ring magnet assembly, wherein arrows indicate the direction of magnetic field inside the magnet. FIG. 2B is a shaded representation showing a uniform magnetic field distribution in the air gap. FIG. 2C is plot of calculated magnetic flux density along the X and Y axes inside the air gap.

FIG. 3A illustrates a shimmed ring magnet assembly having a varying ring magnet thickness (i.e., OD_{M}−ID_{M}) ranging between 0.1 cm and 10.0 cm. Shim thickness (OD_{S}−ID_{S}) and air gap were fixed at 1.8 cm and 1 cm, respectively.

FIG. 3B is a plot showing improvement in magnetic flux density with increasing magnet thickness until a certain threshold is reached. Variable magnetic fields ranging from 0.2 to 0.55 T can be produced for this configuration.

FIG. 4A illustrates a shimmed ring magnet and associated magnetic fields with a varying gap spacing (S_{MS}) ranging between 0 cm and 12.7 cm. The thickness of the magnet and the air gap diameter were fixed at 3.8 cm and 1 cm, respectively.

FIG. 4B is a plot showing variable magnetic flux densities between 0 to 0.55 T inside the air gap with changing spacing between the magnet and the iron core.

FIG. 5 illustrates a shimmed ring magnet combined with a Halbach magnet arrangement and the associated magnetic fields. In this example, the Halbach arrangement includes eight circular magnets (diameter=2.5 mm) that are arranged with alternating magnetizations magnetized inside the central air gap. In this example, ID_{M}=1 cm, OD_{M}=3.8 cm, S_{MS}=0.0 cm, ID_{S}=3.8 cm and OD_{S}=7.6 cm. Magnetic field directions inside the magnets are indicated by arrows. High magnetic fields (˜1.1 T) were calculated for this configuration.

FIGS. 6A-6C illustrate modeling results showing field distributions in a shimmed ring magnet having a square air gap. FIG. 6A shows a shimmed ring magnet assembly having a 3.2 cm square opening (OD_{M}=7.6 cm, S_{MS}=1.0 cm, ID_{S}=7.6 cm and OD_{S}=12.7 cm), wherein arrows indicate the field direction inside the magnet. FIG. 6B illustrates gradient magnetic field distribution in the air gap and FIG. 6C is a plot of calculated magnetic flux density as a function of position along the X and Y directions inside the square air gap.

FIGS. 7A-7B illustrate various magnet configurations.

FIG. 8 is a sectional view of a shimmed ring magnet that is formed of a ring magnet and a shim provided as sections.

FIGS. 9A-9B illustrate calculated magnetic fields produced with a magnet assembly with an air gap having a circular cross-section defined in a rectangular magnet surrounded by a rectangular air gap with no additional air gap between the magnet and the shim.

FIG. 9C is a plan view of the magnet assembly used in the calculations of FIGS. 9A-9B.

FIG. 9D is a plot of magnetic flux density as a function of position along both the x-axis and y-axis in the air gap of the magnet assembly of FIG. 9C.

FIGS. 10A-10B illustrate calculated magnetic fields produced with a magnet assembly with an air gap having a square cross-section defined in a rectangular magnet surrounded by a rectangular air gap with no additional air gap between the magnet and the shim.

FIG. 10C is a plan view of the magnet assembly used in the calculations associated with FIGS. 10A-10B. As shown in FIG. 10C, diagonals of the shim, the magnet, and the air gap are aligned with the magnetization of the magnet.

FIG. 10D is a plot of magnetic flux density as a function of position along both the x-axis and y-axis in the air gap in the magnet assembly of FIG. 10C.

### DETAILED DESCRIPTION

As used in this application, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Disclosed herein are ring magnet assemblies that include ring magnets and co-axial ferromagnetic shims that can be configured to produce magnetic field patterns suitable for magnetic separation and detection applications. In some examples, substantially uniform magnetic fields or gradient magnetic fields can be produced. Several magnet configurations have been evaluated and/or optimized using commercial finite element modeling software, and magnetic field distributions for several representative configurations are provided herein. The disclosed designs typically include a single ring magnet with a co-axial shim ring so that alignment can be simple and straightforward. In representative examples, the disclosed magnets comprise a circular cylinder permanent magnet and a circular cylinder ferromagnetic shim. In some examples, the lengths of the cylindrical magnet and the ferromagnetic shim are less than an outer diameter of the permanent magnet, and are ring-like in appearance. For convenient explanation, such cylindrical parts (with or without bores) are referred to herein in some places as rings. In some examples, particularly for large magnets, rings or cylinders can be formed of multiple pieces for ease of fabrication. As shown below, ferromagnetic shims are configured to be situated exterior to the ring magnet, and in some examples, can slide along the outside surface of the ring magnet.

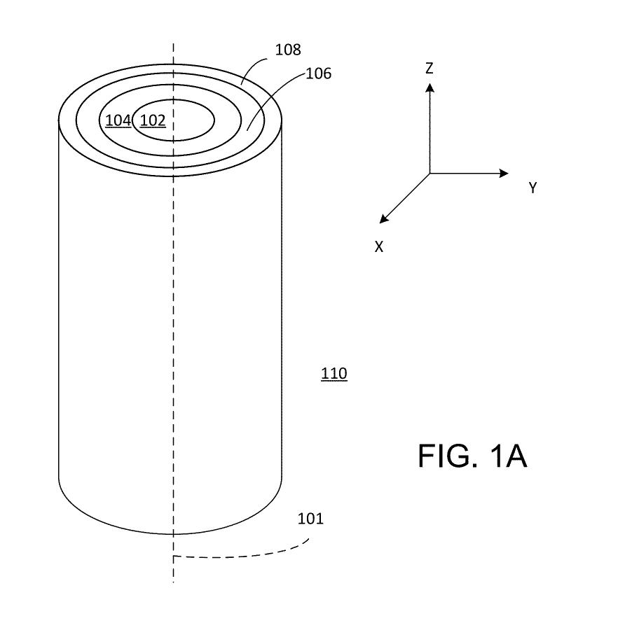

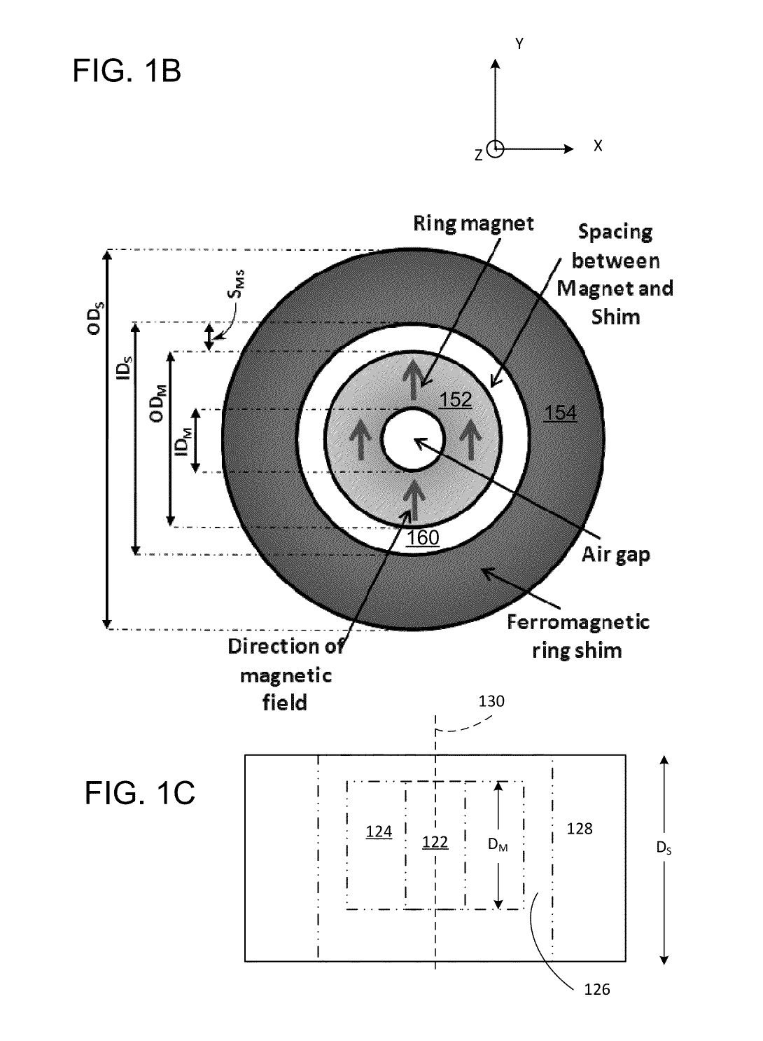

With reference to FIG. 1A, a shimmed magnet assembly 100 includes a ring (cylindrical) magnet 104 situated along an axis 101 and defining an inner air gap 102. A shim ring (shim cylinder) 108 is situated along the axis 101 about the ring magnet 104 so that a shim space 106 is defined between the ring magnet 104 and the shim ring 108. Typically, the ring magnet 104 and the shim ring 108 have circular cross sections in an xy-plane and are centered on the axis 101. The magnet 104 and the shim 108 are generally selected to have lengths sufficient to reduce edge effects in the magnetic field produced in the air gap 102. The ring magnet 104 is magnetized to have a uniform field along a direction in the xy-plane. For convenience, this direction can be assumed to be an x-direction. The shim 108 can be made of any ferromagnetic material as convenient.

FIG. 1B illustrates a cross-section of a shim ring magnet 150 such as that of FIG. 1A. This magnet design comprises a ring shaped permanent magnet 152 of internal diameter ID_{M}, outer diameter OD_{M}, and magnet depth D_{M} measured along the z-axis surrounded by a co-axial ferromagnetic shim 154 of internal diameter ID_{S}, outer diameter OD_{S}, and shim depth D_{S} along the z-axis. The ring magnet 152 and the shim 154 may define an annular shim/magnet air gap of spacing S_{MS}. The ring magnet 152 is magnetized along a diameter so as to be directed within the xy-plane and perpendicular to the z-axis. Any desired magnetic fields (such as uniform or gradient magnetic fields) can be produced in an air gap 160. Field distributions can be selected based on a cross-sectional shape of the air gap. For example, a circular gap provides a uniform magnetic field, while a polygonal (e.g., rectangular) gap provides a gradient magnetic field.

FIG. 1C is an elevational sectional view of a magnet assembly such as that of FIG. 1B. As shown in FIG. 1C, a permanent magnet 124 defines an aperture 122 that extends along an axis 130. A shim 128 is situated about the magnet 124 so as to define an air space 126. In some examples, the air space 126 is omitted and the shim 128 contacts the magnet 124. As shown in FIG. 1C, the depth of the magnet 124 (D_{M}) is less than the depth of the shim 128 (D_{S}) so that the magnet 124 can be situated within the shim 128. However, in other examples, the magnet 124 has a greater thickness than the shim 128 and extends beyond the shim 128. Regardless of depths, the shim 128 and the magnet 124 can be situated so that the magnet extends out of the shim at at least one end. In addition, the magnet 124 need not be placed symmetrically along the axis 130 with respect to the shim 124 with respect to any of the x, y, or z-axes.

In the examples of FIGS. 1A-1C, a variety of magnets and shim materials can be used such as, for example, NdFeB and Fe, respectively. The air gap of the examples of FIGS. 1A-1B can be configured to produce selected field distributions. Substantially uniform magnetic fields can be obtained with a circular air gap, and in one example, field uniformity was superior to that of an equivalent Halbach ring.

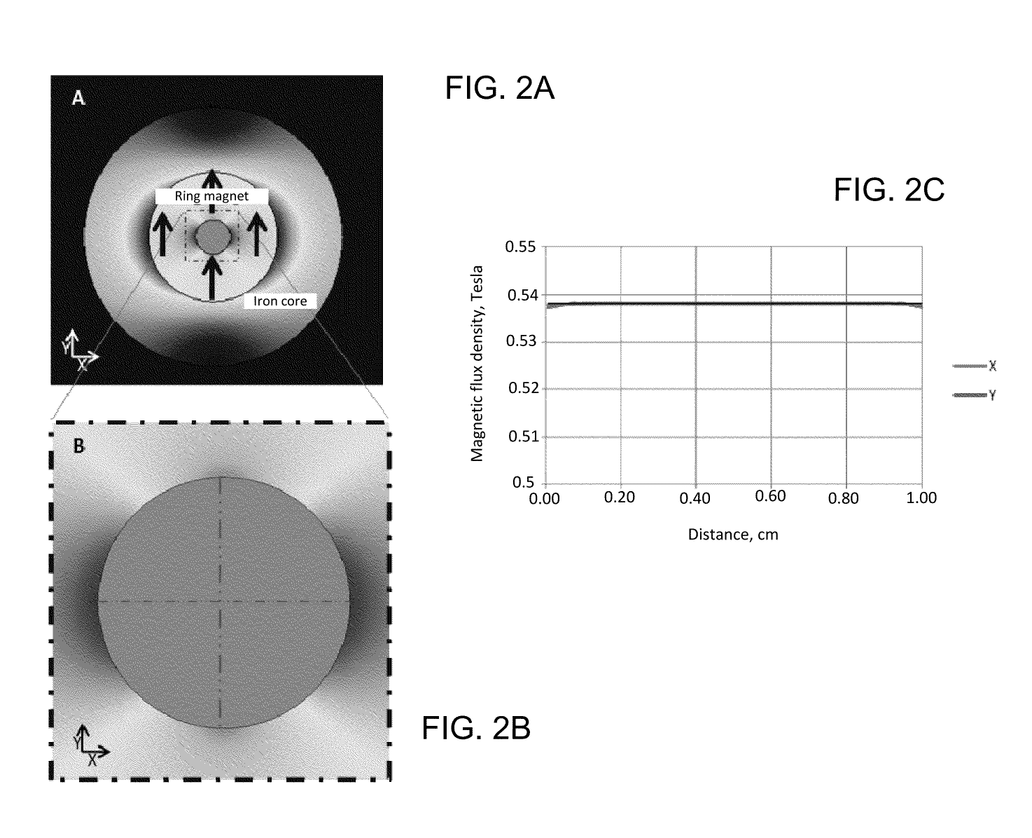

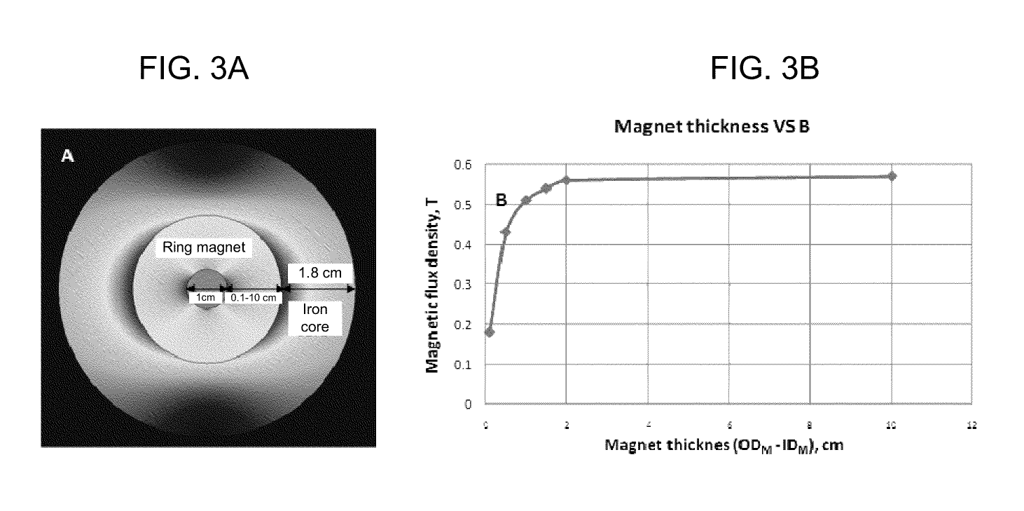

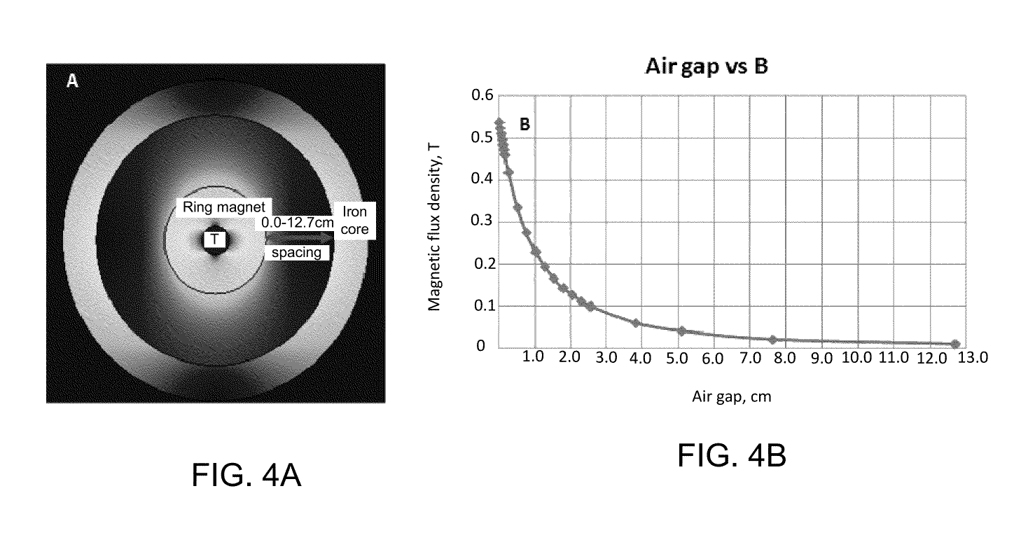

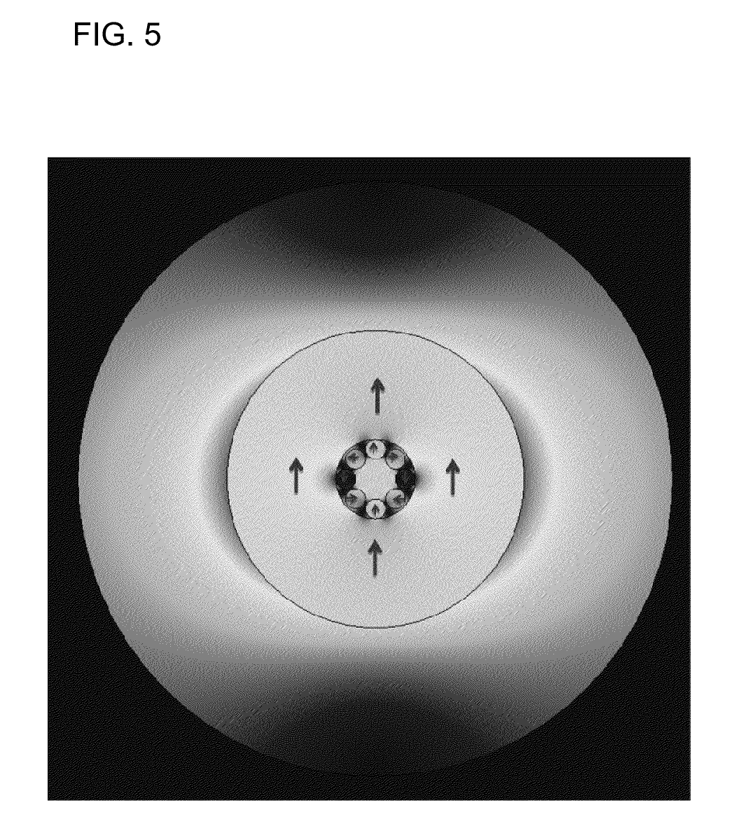

Field results for an example magnet assembly that produces uniform magnetic field are shown in FIGS. 2A-2C. Simulation shows a uniform magnetic field inside the air gap for an NdFeB ring magnet (ID_{M}=1 cm, OD_{M}=3.2 cm) enclosed by an iron shim (ID_{S}=3.2 cm and OD_{S}=7.6 cm). A uniform magnetic flux density inside the air gap can be controlled by varying different geometrical aspects of the design. For example:
1) Varying the ratio (OD_{M}−ID_{M})/(OD_{S}−ID_{S}). FIGS. 3A-3B show magnetic field results for an example magnet assembly having calculated magnetic flux densities ranging from 0.2 to 0.55 T as a function of (OD_{M}−ID_{M}).
2) Varying the spacing between the magnet and the shim (S_{MS}). FIGS. 4A-4B show an example of calculated magnetic flux density inside an air gap varying between 0 T and 0.55 T as a function of S_{MS} ranging between 0.0 cm and 12.7 cm.
3) The designs disclosed can be used in conjunction with Halbach arrangements, i.e. by placing a Halbach arrangement of magnets inside an air gap. For example, by inserting a Halbach arrangement inside the air gap as shown in FIG. 5, uniform magnetic flux densities of ˜1.1 T can be obtained.
4) High gradient systems can also be generated by inserting ferromagnetic structures such as steel wool, steel mesh etc. inside the air gap of the disclosed magnet assemblies.

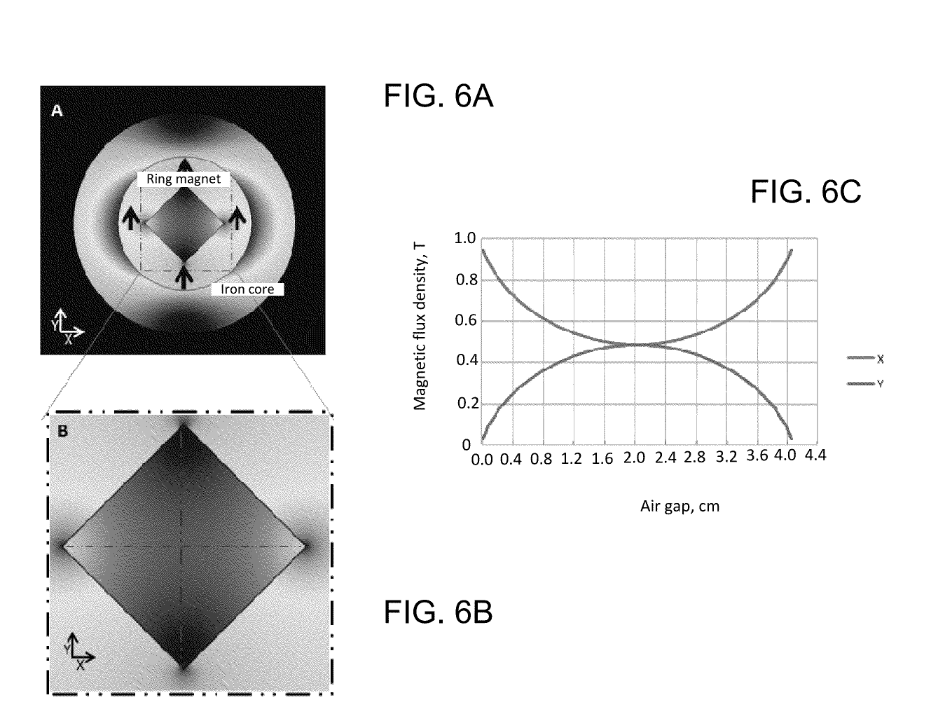

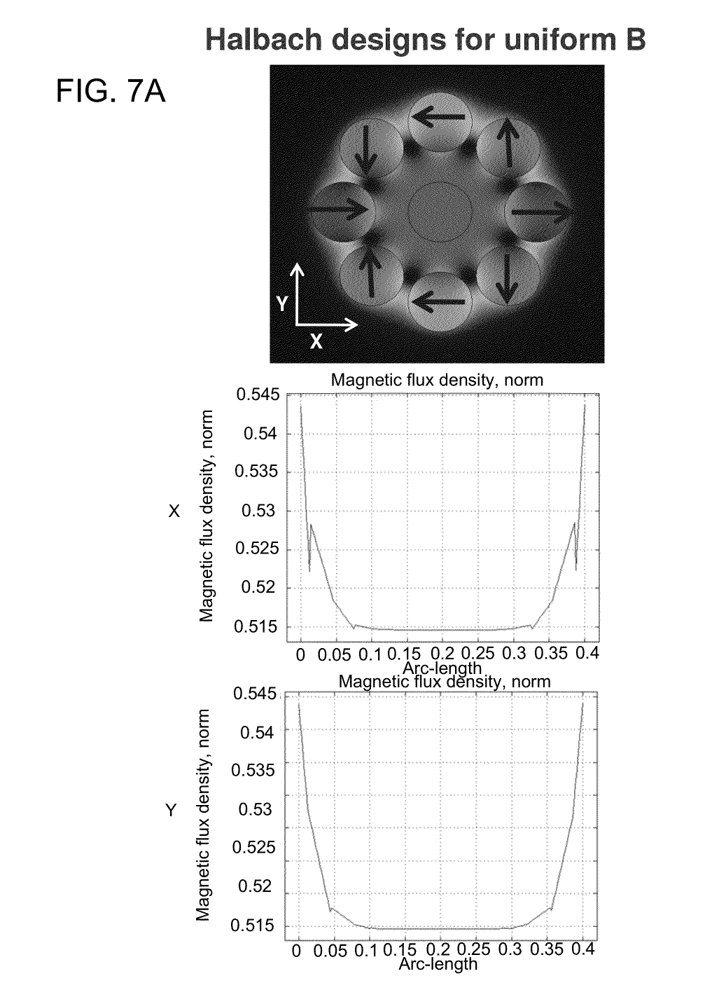

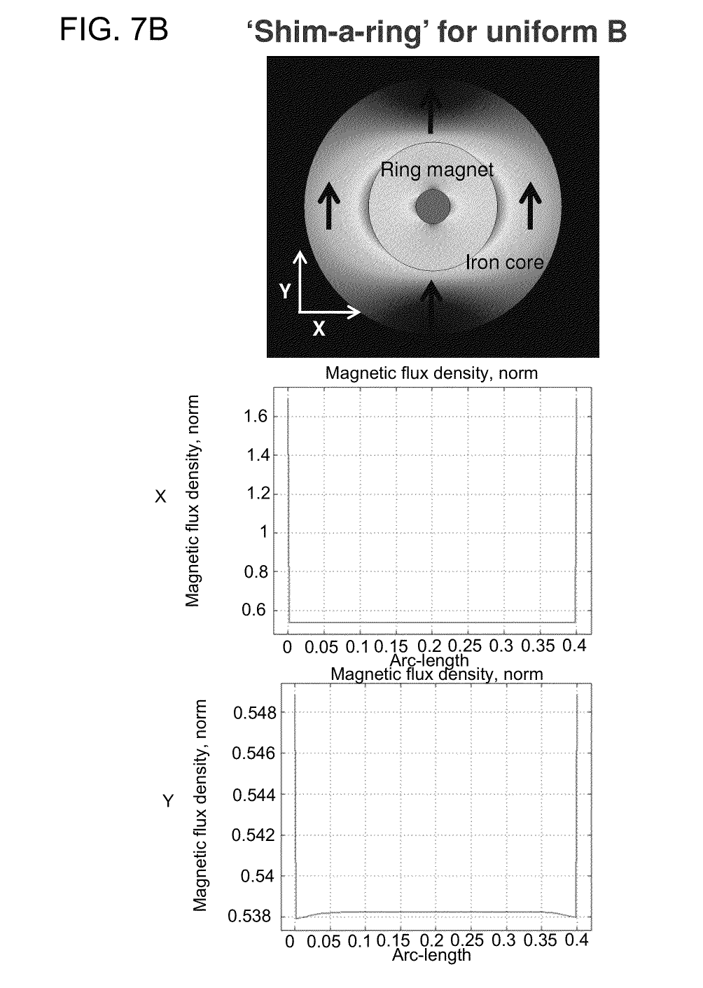

FIGS. 6A-6B pertain to a shimmed ring magnet for production of a magnetic field gradient based on an air gap having a square cross-section, and FIG. 7B illustrates shimmed ring magnets based on an air gap having a circular cross-section for production of uniform fields. FIG. 7A illustrates a Halbach configuration that can be used in an air gap of a shimmed ring magnet assembly.

### Representative Applications

Applications of the disclosed shimmed ring magnets include but are not limited to portable NMR systems, magnetic detection based flow cytometry, Magnetic Resonance Imaging, NMR platforms for cellular/molecular detection, and High Gradient Magnetic Separation. These and other applications are described in G. P. Hatch and R. E. Stelter, Journal of Magnetism and Magnetic Materials 225 (1-2), 262-276 (2001), B. Blümich, F. Casanova and S. Appelt, Chemical Physics Letters 477 (4-6), 231-240 (2009), E. Danieli, J. Perlo, B. Blümich and F. Casanova, Angewandte Chemie International Edition 49 (24), 4133-4135 (2010), M. Zborowski, L. Sun, L. R. Moore, P. Stephen Williams and J. J. Chalmers, Journal of Magnetism and Magnetic Materials 194 (1-3), 224-230 (1999), J. M. D. Coey, Journal of Magnetism and Magnetic Materials 248 (3), 441-445 (2002), Strnat, K. J.; “Modern permanent magnets for applications in electro-technology,” Proc. of the IEEE 78:923-946 (1990), all of which are incorporated herein by reference.

### ADDITIONAL EXAMPLES

In further examples, the central air gap can be defined by a regular or irregular polygon, or can be elliptical, arcuate, a combination of a polygon and a curve such as a portion of a circle or oval. The outside surface of the ring magnet can also assume these other shapes, as desired. An air gap can be provided between a ring magnet and the shim, or the shim can fit with substantially no air gap, or can have an arbitrary shape. While typically the air gap internal to the ring magnet is a central air gap, in other examples the air gap need not be centered on an axis of the ring magnet or the shim, and the ring and the shim can be arranged to be non-coaxial as well.

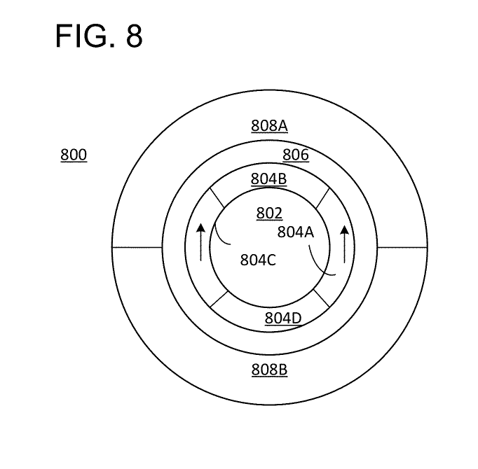

With reference to FIG. 8, a magnet assembly includes a magnet 804 comprising sections 804A-804D situated about an air gap 802, and a shim 808 comprising sections 8008A-808B, but magnets and shims can be produced as different arrangements of segments. As shown in FIG. 8, the sections 804A-804D are magnetized so as to correspond to a diametrical magnetization as assembled. In the example of FIG. 8, a gap 806 between the ring magnet 804 and the shim 808 can be an air gap, or a non-magnetic spacer can be provided, conveniently as a cylindrical shell of a suitable material. In some examples, the air gap can be configured to accommodate a specimen container. For example, a cross section of the air gap 802 can be selected to be substantially the same as that of a specimen tube, or a cylindrical shell of non-magnetic material can be situated in the air gap 802 having a bore sized to accommodate a specimen tube or other container or specimen shape.

The examples above are based on concentric ring magnets and shims for convenient explanation. In other embodiment, magnets and shims can be provided in other shapes. For example, a magnet assembly can comprise a co-axial rectangular magnet and a rectangular shim. Other examples include triangular magnets and triangular shims, or arbitrary polygonal magnets and corresponding polygonal shims. Typically, a magnet and a shim are aligned coaxially, and the magnetization is orthogonal to the axis.

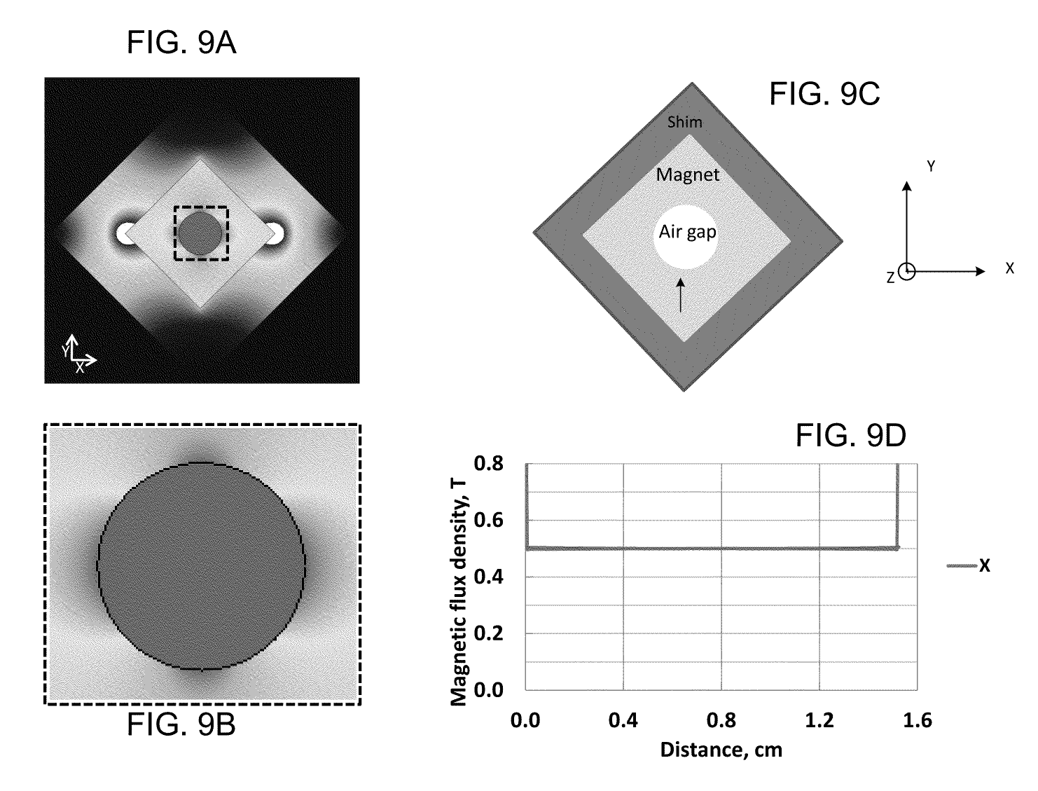

FIGS. 9A-9B illustrate calculated magnetic fields produced with an air gap having a circular cross-section defined in a rectangular magnet surrounded by a rectangular air gap with no additional air gap between the magnet and the shim. A plan view of the magnet assembly is shown in FIG. 9C, and FIG. 9D is a plot of magnetic flux density as a function of position along both the x-axis and y-axis in the air gap. In the example of FIGS. 9A-9D, a substantially constant flux density is produced in the air gap. The magnet and the shim are assumed (for purposes of calculation) to extend arbitrarily along the z-axis so that end effects can be disregarded.

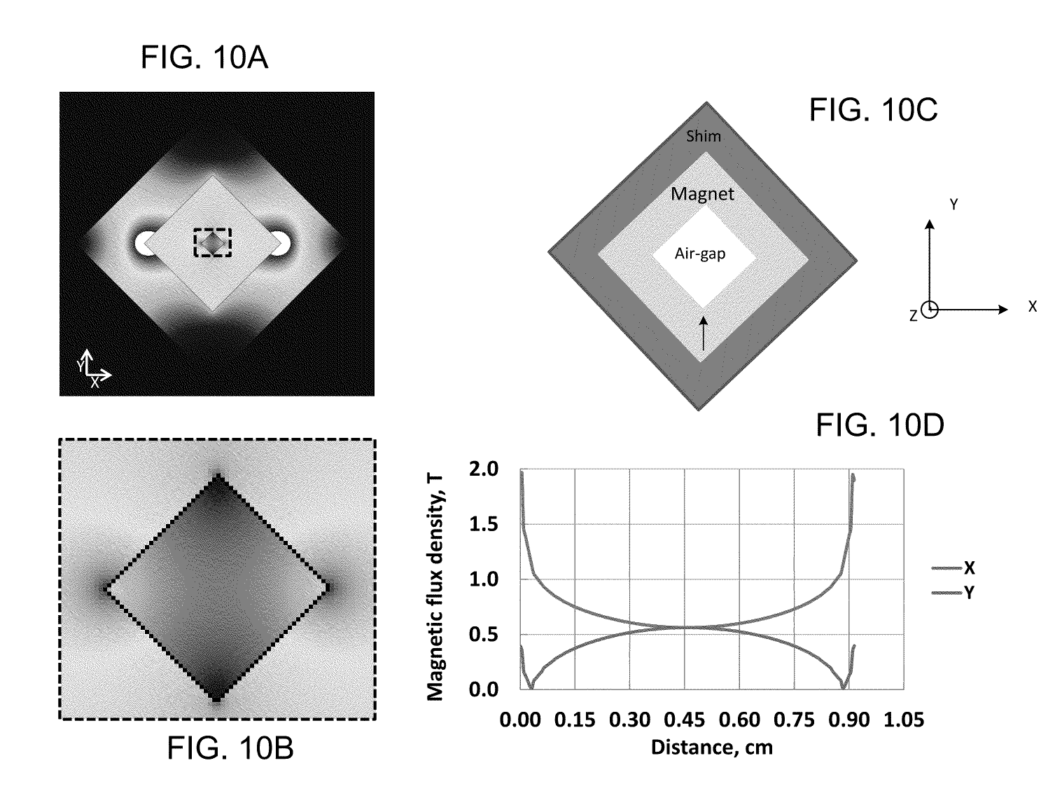

FIGS. 10A-10B illustrate calculated magnetic fields produced with an air gap having a square cross-section defined in a rectangular magnet surrounded by a rectangular air gap with no additional air gap between the magnet and the shim. Diagonals of the shim, the magnet, and the air gap are aligned with the magnetization of the magnet. A plan view of the magnet assembly is shown in FIG. 10C, and FIG. 10D is a plot of magnetic flux density as a function of position along both the x-axis and y-axis in the air gap. In the example of FIGS. 10A-10D, a substantially constant gradient flux density is produced in the air gap. The magnet and the shim are assumed (for purposes of calculation) to extend arbitrarily along the z-axis so that end effects can be disregarded.

Magnets can be formed of any of a variety of materials such as are known, including, for example, FeNdB and SmCo materials. Shims can similarly be formed of any of a variety of ferromagnetic materials as desired.

The examples described above are provide for convenient illustration and are not to be taken as limiting the scope of the disclosure. We claim all that is encompassed by the appended claims.

We claim:

1. A magnet assembly, comprising:
a permanent magnet defining an air gap;
a ferromagnetic shim situated about the permanent magnet.

2. The magnet assembly of claim 1, wherein the permanent magnet and the ferromagnetic shim are cylindrical, the ferromagnetic shim is situated so as to be concentric with the permanent magnet, and a permanent magnet magnetization is directed so as to be in a plane perpendicular to an axis of the permanent magnet.

3. The magnet assembly of claim 2, wherein the cylindrical permanent magnet has a magnetization that is directed along a diameter of the cylindrical cross section of the cylindrical permanent magnet.

4. The magnet assembly of claim 3, wherein the air gap in the permanent magnet has a circular cross-section concentric with the permanent magnet.

5. The magnet assembly of claim 3, wherein the air gap in the permanent magnet has a square cross-section centered with the permanent magnet and having a diagonal of the square cross-section aligned with the magnetization of the permanent magnet.

6. The magnet assembly of claim 1, further comprising a Halbach array situated in the air gap in the permanent magnet.

7. A method, comprising:
selecting a magnetic field distribution in at least one plane;
providing a ring permanent magnet having an internal air gap associated with the selected magnetic field distribution, wherein the magnetization is parallel to the plane; and
situating a ferromagnetic shim about the permanent magnet.

8. The method of claim 7, wherein the magnetization of the magnet is parallel to a diameter of the ring.

9. The method of claim 7, wherein the internal air gap has a circular cross-section.

10. The method of claim 7, wherein the ring magnet and the shim are circular cylinders.

11. The method of claim 7, wherein the ring magnet and the shim have non-circular cross-sections in a plane parallel to the magnetization.

12. The method of claim 7, wherein the internal air gap has a rectangular cross-section.

13. The method of claim 12, wherein a diagonal of the rectangular cross-section is aligned with the magnetization of the permanent magnet.

14. The method of claim 7, wherein the cross-section of the shape of the air-gap is a circle or polygon.

15. The method of claim 7, wherein the cross-sections of the shape of the inner and/or outer surfaces of the magnet are a circle or polygon.

16. The method of claim 7, wherein the cross-section of the shape of the inner and/or outer surface of the shim is a circle or polygon.

17. The method of claim 7, wherein the air gap, the outer surface of the magnet, and the inner and outer surfaces of the shim have similar shapes.

18. The method of claim 7, wherein the air gap, the outer surface of the magnet, and the inner and outer surfaces of the shim have similar shapes that are aligned with respect to each other.

19. A magnet assembly, comprising:
a magnetized cylinder having a central bore and having a magnetization that is along a direction of a selected radius of the cylinder;
a ferromagnetic shim situated about the magnetized cylinder; and
a first set of cylindrical magnetics and a second set of cylindrical magnets alternately situated at an inner surface of the central bore such that the first set of magnets have magnetizations parallel to the magnetization of the magnetized cylinder and the second set of magnets have magnetizations perpendicular to the magnetization of the magnetized cylinder.

20. The magnet assembly of claim 19, wherein the ferromagnetic shim is spaced apart from the magnetized cylinder so as to form an air gap.

21. The magnet assembly of claim 20, wherein the ferromagnetic shim comprises first and second half cylindrical shells situated to form a cylindrical shell about the magnetized cylinder and the magnetized cylinder comprises a plurality of sections.

22. The magnet assembly of claim 19, wherein the magnets of the first set of magnets have alternating magnetizations and the magnets of the second set of magnets have alternating magnetizations.
